(19) United States
(12) Patent Application Publication
(10) Pub. No.: US 2013/0082821 A1
(43) Pub. Date: Apr. 4, 2013

(54) PROXIMITY-BASED GLUCOSE METER FUNCTION ACTIVATION

(71) Applicants: Steven A. Bousamra, Carmel, IN (US); Ulrich Porsch, Weinheim (DE); John F. Price, McCordsville, IN (US)

(72) Inventors: Steven A. Bousamra, Carmel, IN (US); Ulrich Porsch, Weinheim (DE); John F. Price, McCordsville, IN (US)

(73) Assignee: Roche Diagnostics Operations, Inc., Indianapolis, IN (US)

(21) Appl. No.: 13/252,439

(22) Filed: Oct. 4, 2011

(51) Int. Cl. G08B 29/00

(52) U.S. Cl. 340/5.65

(57) ABSTRACT

A method and system in which a short range wireless signal containing an activation code is received with a glucose meter. Upon receiving the signal, the glucose meter awakens from a low power state. A dormant function on the glucose meter that corresponds to the activation code is activated in response to receiving the short range wireless signal. In one example, the glucose meter includes an RFID tag configured to receive an RFID signal. A device reader coupled to a health care provider computer transmits the RFID signal. The dormant function on the glucose meter can include any number of functions, such as a structured glucose test and/or the ability to automatically generate reports.

### BACKGROUND

There has been an explosion in the growth of home diagnostics testing such as for blood glucose monitoring. With this explosive growth there has been a development of numerous features and tests specifically for the blood glucose monitoring environment. However, the infrastructure for the features may not be available at the time the blood glucose meter is going to market. For example, the underlying supporting software for the function might not be completely developed and/or appropriate government approval might not have been received at that point. Glucose systems have been proposed in which a code key is used to activate or unlock features of the glucose meter. This unlocking by the code key allows additional features to be implemented through the glucose meters such as additional structured tests or other functionalities. However, these code keys add expense to the overall system and create a number of logistical issues, such as the code keys being lost and/or used in the wrong situations. Other glucose systems have been proposed in which a password is used to unlock certain features in the glucose meter. As should be appreciated, once the password is disclosed, it is easily copied to other devices such that it might be used in inappropriate circumstances.

Another difficulty is the ability to readily transfer information between glucose meters or other medical devices and the physician's computer. Current devices allow health care providers to download data, generate reports, and/or configure device parameters; however, the process of doing so is often complex and requires valuable time and effort of either the health care provider or another person. Most medical device manufacturers utilize different proprietary systems for communicating with their respective platforms. This forces health care providers to support numerous software applications, let alone the health care providers needing to deal with different cabling systems used to hook up the various devices and glucose meters. As a result, very few health care providers download or use data from patient glucose meters and other devices.

Thus, there is a need for improvement in this field.

### SUMMARY

The system and method described herein address the above-discussed issues as well as other issues by having a reader and a meter in which the reader transmits a code to automatically configure the meter. To address any privacy concerns, the meter can request authorization from a patient before any configuration occurs. Using a proximity-based system avoids any issues such as passwords being transferred to other meters. In one example, the reader transmits the code signal that in turn wakes up the glucose meter from a sleep state. The glucose meter then determines whether the code transmitted by the reader is an appropriate one, and, if so, the meter unlocks a specific feature, such as a particular structured testing protocol, based on the code transmitted. The code can be used to enable or disable a feature or function of the glucose meter directly, or establish a communication link in which the feature is programmatically enabled or disabled. In another example, the code is used to automatically initiate data transfer and printing of reports. This makes it as simple as possible for the health care provider to review any standard reports from the glucose meter. For instance, the patient brings their meter into a physician's office and places the meter in close proximity to the reader, and the report is automatically printed out on the physician's printer. This helps speed the process and eliminates wasted time by the physician making the appropriate selections for downloading data. It should be appreciated that other functions can be initiated using this protocol. The reader itself can come in many forms, such as a peripheral device that is attached to a personal computer or integrated into a personal computer and/or a standalone device.

In one particular example, the meter has a radio frequency identification (RFID) chip. The RFID chip or tag can be passive (i.e., using no battery), active (with an onboard battery that always broadcasts), and/or a battery-assisted passive configuration (with a small onboard battery that is activated in the presence of an RFID reader). In this particular example, the reader at the health care provider's computer broadcasts a code that awakens the RFID chip or tag on the meter. Upon being awakened, the meter determines whether or not the code is a proper code for reconfiguring the meter. If the appropriate code is detected, the meter is reconfigured such as to perform a specified structured test stored in memory and/or to directly print a report via the health care provider's printer.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a diagram of one example of a glucose monitoring system that utilizes proximity-based activation.

FIG. 2 is a block diagram of a device reader shown in FIG. 1.

FIG. 3 is a block diagram of a glucose meter used in the FIG. 1 system.

FIG. 4 is a flowchart illustrating a technique for activating functionality on a glucose meter or other medical device from the perspective of a health care provider system.

FIG. 5 is a flowchart illustrating a technique for configuring the glucose meter or other medical device to perform a particular function.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

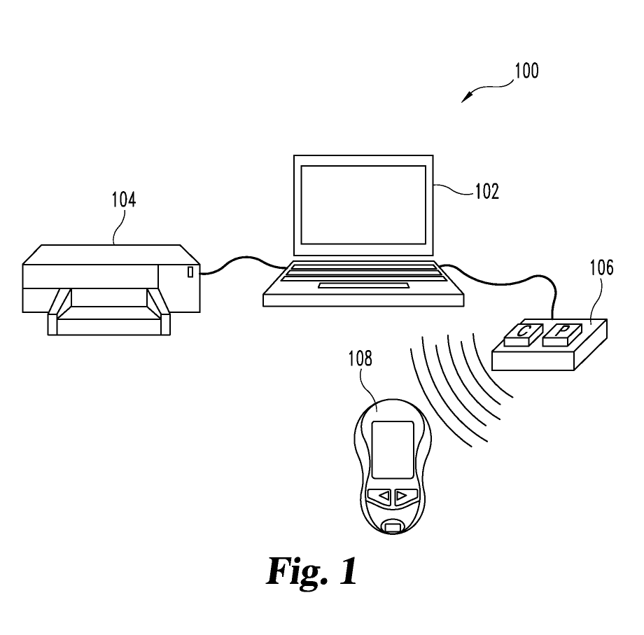

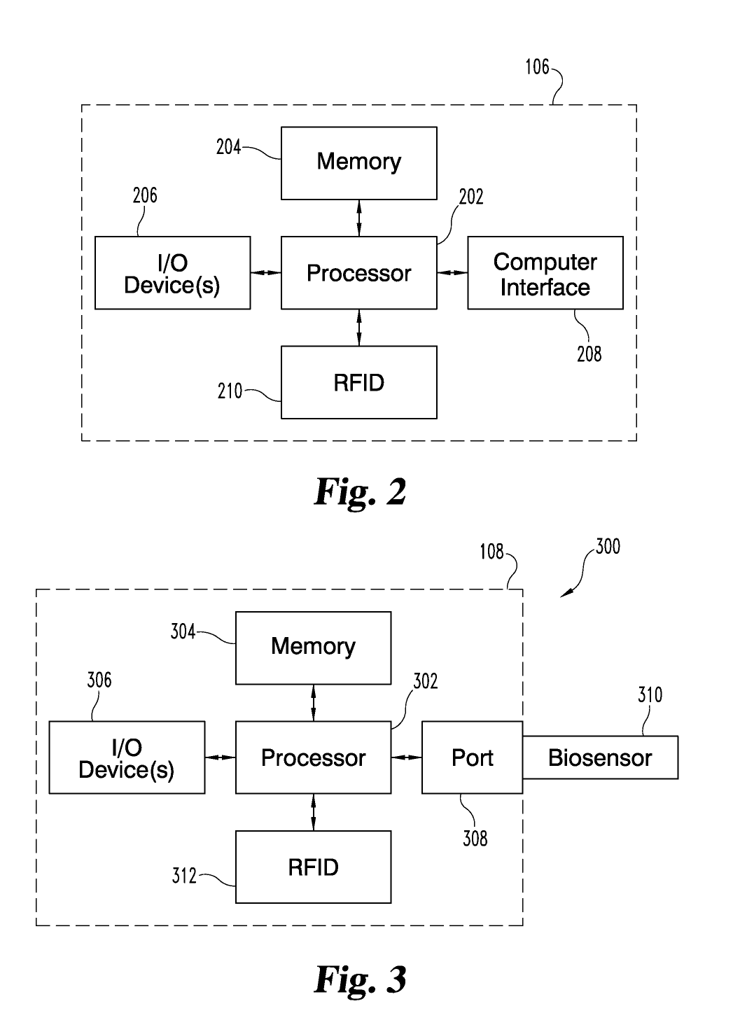

For the convenience of the reader, it should be initially noted that the drawing in which an element is first introduced is typically indicated by the left-most digit(s) in the corresponding reference number. For example, a component identified with a one-hundred series reference number (e.g., 100, 101, 102, 103, etc.) will usually be first discussed with reference to FIG. 1, and a component with a two-hundred series reference number (e.g., 200, 201, 202, 203, etc.) will usually be first discussed with reference to FIG. 2.

FIG. 1 illustrates a glucose monitoring system 100 that is able to configure glucose meters that are in close proximity according to one embodiment. The system 100 includes a computer 102, a printer 104 operatively connected to the computer 102, and a device reader 106 that is operatively connected to the computer 102. In one example, the computer 102 is located at a physician's office, but it should be appreciated that the computer 102 can be located at other types of health care provider offices. As will be explained below, the printer 104 is used to print out reports and other information for the physician or other healthcare provider. The device reader 106 is configured to communicate with one or more glucose meters 108. The health care provider computer 102 is used to analyze the glucose testing results from the glucose meter 108 as well as to configure the glucose meter 108. The computer 102 programs and/or communicates with the glucose meter 108 via the device reader 106. The device reader 106 is configured to wirelessly communicate with the glucose meter 108 using a short range wireless protocol, such as radio frequency identification (RFID) protocol. Using a short range proximity-based protocol such as RFID, rather than using some long range-type of communication protocol, ensures that the glucose meter 108 is the one desired to be programmed. In one particular example, the short range signal has a maximum range of two (2) meters from the device reader 106, and in another example, the maximum range is one (1) meter. Again, using such short range signals ensures that other glucose meters are not accidentally reprogrammed. Moreover, the low-powered nature of the RFID protocol helps to reduce power consumption on the glucose meter to extend its operational life without the need to change or recharge batteries. In addition, using a low power communication protocol helps to enhance privacy, especially for sensitive medical data. The low power communication protocol reduces the risk of detection by snooping devices, such that it is more difficult for unauthorized devices to download sensitive medical data from the glucose meter 108. Furthermore, using a wireless protocol, rather than communicating through a cable, avoids the many difficulties associated with non-standardize cabling from different medical device manufacturers. As alluded to above, the physician or other health care provider via the computer 102 is able to remotely activate various functions on the glucose meter 108 via the device reader 106 using these short range wireless protocols.

As noted before, a structured testing protocol or some other functionality might be developed for a particular meter before the software is fully tested and approved. Considering the long lead times for software development in some cases, it is best suited to pre-code the glucose meter 108 with the particular functionality before the overall system architecture is approved and/or finalized. The particular function, such as a structured testing protocol or configuration data, remains dormant on the glucose meter 108 until properly activated by the device reader 106. As noted above, having this ability to activate certain functionalities of the glucose meter 108 after the glucose meter 108 has been introduced to the market provides greater flexibility and improved functionality of the glucose meter 108. Utilizing a close proximity-based type system ensures that only the meters desired to be updated are, in fact, updated. This is in sharp contrast to password-based systems in which the functionality can be easily copied and duplicated on other meters by copying of the password. This also addresses the logistics concerns of programming keys to activate the glucose meter. Since it is proximity based, only the physicians and/or users authorized to perform the desired functionality are able to have access to the newer features. This provides an extra layer of security to ensure that only those properly trained are able to use the newer functionality. For example, this technique allows physicians to consult with and train patients about the particular procedures for a new structured test before activating the test.

To program the glucose meter 108, the physician or other health care provider can for example select a menu item on the display of the computer 102 or simply press a button on the device reader 106 to activate an RFID beacon that provides a code which in turn awakens the glucose meter 108. In one particular example, after placing the glucose meter 108 near the reader 106, the physician selects a particular structured test they want activated from a list displayed on the computer 102. After selecting the test, the physician selects an activate function button on the display of the computer 102, and the computer 102 transmits an appropriate signal to the reader 106. The reader 106 in turn transmits an RFID signal that is coded to awaken and activate the particular structured test on the glucose meter 108. In another example, the physician simply presses a button on the reader 106 to transmit the RFID signal for activating the particular functionality on a glucose meter 108 in close proximity to the reader 106.

Upon awakening, the glucose meter 108 determines whether the code from the reader is an appropriate code for activating a then-dormant function, such as a structured test, within its memory. As should be appreciated, other functionality can be activated in a similar manner. For instance, the system 100 can also be designed to automatically download and print reports based on data from the glucose meter 108. This helps with physician efficiency so that they do not have to even access the computer to have the report when meeting with the patient.

FIG. 2 illustrates a block diagram of the device reader 106. As shown, the device reader 106 includes a processor 202, memory 204, an input/output (I/O) device 206, a computer interface 208, and an RFID reader 210 (e.g., a short range wireless transceiver). The processor 202 is used to process information and commands, and the memory 204 stores data, such as glucose readings, structured tests, various functions, and procedures. For instance, the processor 202 can include a microprocessor and/or other electronics that are configured to process data. Memory 204 is used to store data on a permanent or temporary basis. The memory 204 can include random access memory (RAM), read only memory (ROM), some combination of both, and/or other types of memory as would occur to those skilled in the art. The I/O device 206 is used to enter data and provide information. In one example, the I/O device 206 includes a touch screen display, but it can include other types of I/O devices. The computer interface 208 acts as a communication pathway between the reader 106 and the computer 102. For example, the reader 106 can receive signals from the computer 102 to broadcast a specific command to the glucose meter 108 via the computer interface 208. The computer 102 can also receive information from the glucose meter 108, such as test data, via the computer interface 208 of the reader 106. The RFID reader 210 wirelessly transmits information between the reader 106 and the glucose meter 108. In one example, the RFID reader 210 includes a fixed RFID reader that is set up to provide specific interrogations to create a bubble of RF energy that can be tightly controlled. This helps to limit the reading area for the RFID tags on the glucose meter 108 to avoid accidental activation of particular features. However, it should be appreciated that in other examples the reader can include a mobile RFID-type reader. It should be recognized that the reader 106 can be configured differently than is shown in FIG. 2.

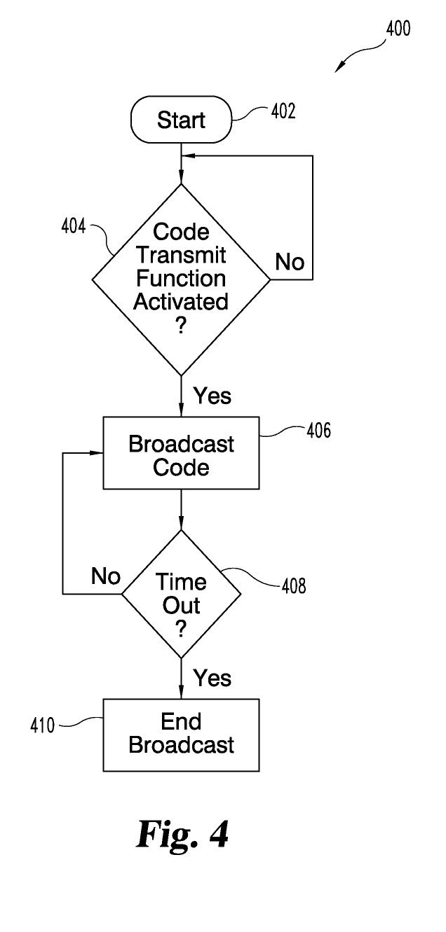

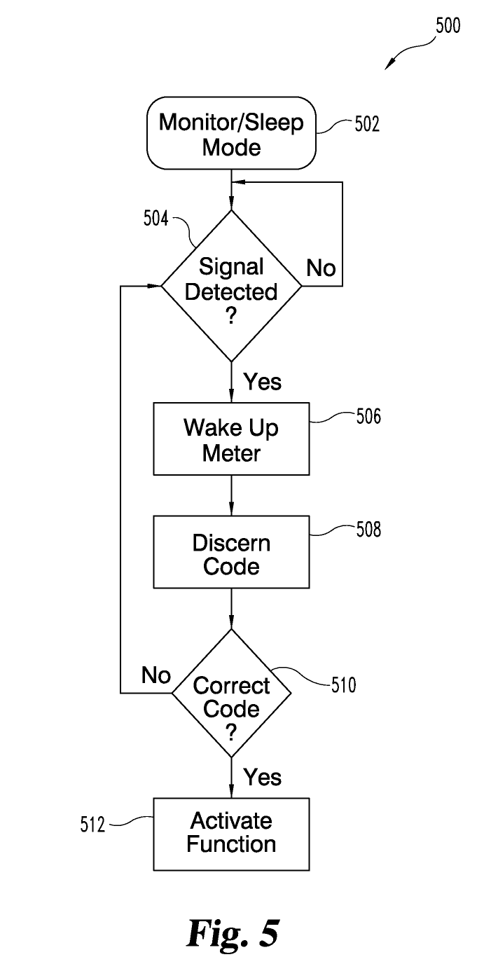

The processor 202 along with the memory 204 and other components of the reader 106 are designed to perform the techniques described herein. In the discussion below of the various techniques in conjunction with FIGS. 4 and 5, it should be recognized that the methods performed by the reader 106 use the processor 202, internal memory 204, I/O device 206, computer interface 208, and RFID reader 212 as well as other components. These techniques can be programmed as software, firmware, and/or hard coded in the hardware of the reader 106. Certain aspects of these techniques can be performed either alone or in conjunction with the computer 102.

FIG. 3 illustrates a block diagram of a meter system 300 used to communicate with the device reader 106. In the illustrated embodiment, the meter system 300 includes a discrete test type of glucose meter. However, the glucose meter 108 can be configured in other manners than as illustrated. For example, the glucose meter 108 can include a continuous monitoring-type meter and/or a non-invasive-type meter. As illustrated, the glucose meter 108 includes a processor 302 for processing data, memory 304 for storing data, an input/output (I/O) device 306, and a sensor port 308 to which a disposable biosensor 310, such as a test strip, is attached. The processor 302 can, for example, include a microprocessor and/or other electronics that are configured to process biosensor data. The memory 304 can include random access memory (RAM), read only memory (ROM), some combination of both, and/or other types of memory as would occur to those skilled in the art. The I/O device 306 can include one or more devices such as buttons, displays, touch screens, speakers, microphones, as well as other types of devices either singularly or collectively for inputting and outputting data. In one particular example, the I/O device 306 includes a screen and buttons with which the user interacts to enter blood glucose data as well as other information.

An RFID tag 312 (e.g., short range wireless receiver or transceiver) is configured to receive and transmit information with the RFID reader 210 in the reader 106. In the illustrated example, the RFID reader 210 includes the RFID tag 312 for communicating using the RFID protocol. As noted before, the RFID protocol helps to conserve power consumption of the glucose meter 108. However, it is envisioned that other types of close proximity-based communication protocols can be used. For instance, the tag 312 can include a near field communication wireless type of communication device, such as a BLUETOOTH™ type transceiver, that would communicate with the device reader 106 via a BLUETOOTH™ type connection or through an optical type connection, such as through an infrared transceiver.

The sensor port 308 allows the disposable biosensor 310 to be coupled to the glucose meter 108. For example, when the glucose meter 108 is a blood glucose meter, the sensor port 308 provides an electrical connection between the glucose meter 108 and the biosensor 310. In one example, the biosensor 310 is a disposable test strip, but it is contemplated that in other variations all or part of the biosensor 310 can be integrated into the glucose meter 108 so as to not be disposable. It should be recognized that the illustrated example is merely a simplified diagrammatic view of the meter system 300, and it is contemplated that the meter system 300 can include other components normally found in meters. Moreover, the communication paths illustrated by the arrows can be configured differently in other embodiments. Although components such as the processor 302 and internal memory 304 are illustrated as distinct components, it should be appreciated that one or more of the components in the meter system 300 can be integrated together to form a single unit. Likewise, the individual components can be divided into various subcomponents to form and be made of multiple units. For example, the internal memory 304 may include multiple internal memory units.

The processor 302 along with the internal memory 304 and other components of the meter system 300 are designed to perform the techniques described herein. In the following description of the flow charts, it should be recognized that the methods or techniques are performed using the processor 302, internal memory 304, I/O device 306, sensor port 308, and RFID tag 312 as well as other components of the meter system 300. These techniques can be programmed as software, firmware, and/or hard coded in the hardware of the meter system 300.

FIG. 4 illustrates a flow diagram 400 from the perspective of the health care provider's side of the system 100. In particular, it illustrates how the computer 102 and device reader 106 configure or otherwise interact with the glucose meter 108. For explanation purposes, the technique will be described from the perspective of the device reader 106, but is envisioned that this same or similar technique can be used via the computer 102. After initializing the device reader 106 in stage 402, the device reader 106 determines whether the code transmission function has been activated in stage 404. As noted above, this code transmission function can be activated in a number of ways. In one particular example, after placing the glucose meter 108 near the reader 106, the physician selects a particular function, such as a structured test, they want activated from a list displayed on the computer 102. After selecting the function, the physician selects an activate function button on the display of the computer 102, and the computer 102 transmits an appropriate signal. The computer 102 in stage 404 can transmit a signal to the computer interface 208 of the device reader 106 indicating that a particular function should be activated on the glucose meter 108. In another example, the device reader 106 can monitor the I/O device 206, such as a button, to determine if it has been depressed or otherwise activated in stage 404. If no such action has been detected in stage 404, the device reader 106 continues to monitor for activity, as is shown by the arrow in FIG. 4.

Once the transmit function is activated, the device reader 106 broadcasts an appropriate code to activate the function on the glucose meter 108. For example, once the button is depressed, the processor 202 of the device reader 106 broadcasts via the RFID reader 210 a code for the particular configuration function activated in stage 406. For instance, if the physician wishes to utilize a specific structured test that has been preprogrammed in the internal memory 304 of the glucose meter 108, the device reader 106 will broadcast the code appropriate for activating that particular structured testing function. In another example, upon the physician pressing a print report button on the device reader 106, the device reader 106 can send a code to initiate printing of a particular predefined report. Once received by the glucose meter 108, this print report code causes the glucose meter 108 to transmit information to the device reader 106 for the report via the RFID tag 312. The device reader 106 then forwards the report information to the computer 102, which in turn automatically prints the report via the printer 104. The code can be a binary signal indicating an identification number for a particular function, but the code can take other forms in other examples.

To avoid issues with the device reader 106 constantly broadcasting the code and to improve security, the device reader 106 incorporates a timeout function that only allows the device reader 106 to broadcast the code for a limited period of time. This helps to conserve energy as well as prevent accidental activation of functions on other glucose meters. In stage 408, the device reader 106 determines whether or not the predetermined time period has elapsed. If the time has not elapsed, the device reader 106 continues to broadcast the code in stage 406. Otherwise, in stage 410 the device reader 106 ends the broadcast and proceeds to process any subsequent information. As noted before, the device reader 106 can for example initiate printing of a particular predefined report via the printer 104.

FIG. 5 will now be used to describe this technique from the perspective of the glucose meter 108. While the technique will be described with reference to activating a particular feature or function, it should be appreciated that this technique can also be used to deactivate one or more functions. Specifically, FIG. 5 shows a flow diagram 500 illustrating a technique for configuring the glucose meter 108 to perform a particular function. This technique for example can include configuring the glucose meter 108 to perform a particular function, such as a structured test, that was in a deactivated or hibernation state and/or automatically output information, such as automatically printing reports for the physician or other health care provider. In stage 502, the glucose meter 108 is in a low power or sleep mode so as to conserve energy. It should be recognized that this technique can also be initiated when the glucose meter 108 is in an active state. In stage 504, the RFID tag 312 monitors for a particular RFID signal from the device reader 106. As noted before, one of the many benefits of using an RFID tag is the low power usage and inexpensive price which makes it easily incorporated into glucose meters. If no signal is detected in stage 504, the processor 302 continues in the sleep mode in stage 502. Again, it should be recognized that in stage 502, the glucose meter 108 can be monitoring for the RFID signal when in an awake or powered-on state as well. In stage 504, if the RFID code signal is detected from the device reader 106, the processor 302 of the glucose meter 108 wakes up the meter in stage 506, if needed. Once more, if the glucose meter 108 is already in a powered-on or awake state, stage 506 does not need to be performed.

In the now powered-on mode, the glucose meter 108 discerns the code being broadcast by the RFID reader 210 of the device reader 106. The processor 302 via the memory 304 determines whether the code being broadcast is a code for activating a particular function stored in the glucose meter 108. In stage 510, the processor 302 of the glucose meter 108 determines whether the code is an appropriate code for the glucose meter 108. For example, the processor 302 compares the received code with a list of codes in memory 304. If there is no match, the glucose meter 108 returns to its previous state, either an awake state or sleep mode, in stage 502. Alternatively or additionally, the glucose meter 108 can provide an alert via the I/O device 306 that the code was incorrect and/or not recognized. An error code can also be transmitted to the device reader 106, which in turn can cause the computer to display or otherwise output an indication that an error has occurred. When a particular code is appropriately designated for the glucose meter 108, the glucose meter 108 in stage 512 activates a particular function stored in memory 304. As noted before, this function can include, for example, activating a particular structured test functionality in which questions are asked alongside recording various glucose meter readings. Alternatively or additionally, the function activated can be an automatic downloading of data from the glucose meter 108 onto the device reader 106 for automatic printing by the printer 104 and/or automatic displaying on the display of the computer 102. Again, it should be recognized that in stage 512 one or more functions can be deactivated, instead of being activated. Moreover, certain functions can be deactivated while at the same time other functions can be activated in stage 512. Simultaneous activation and deactivation of functions in stage 512 can for example occur when a newer function, such as a new testing protocol, replaces an older one.

It should be appreciated that the various stages in the above-described technique can occur in a different order than is shown in the flowcharts and/or various stages can be combined together. For instance, the signal detection stage 504 and code discerning stage 508 in FIG. 5 can occur at the same time before the glucose meter 108 is awakened in stage 506. It again should be appreciated that this technique can be used to activate and/or deactivate functions. For example, this technique can be used to change the state of a function, such as a testing protocol, from an activated state to a deactivated state or vice-versa. This technique can be further used to simultaneously or sequential activate and/or deactivate various combinations of functions. Some of these functions can include, but are not limited to, automatic downloading of data, enabling menus (e.g., hiding menus or menu items like structured test setup menus), disabling menus (i.e., turning off certain menus), feature enablement/disablement, configuration enablement/disablement, and/or status review enablement/disablement (such as adherence to protocols, sampling frequency, and the like), to name just a few.

While technique was described as being used in a physician's office, the technique and system can be used on other environments, such as in the patient's home. For example, the system 100 can be used to enable and/or disable alerts for the user. For example, if the system detects a keyfob or a cell phone of the user, then the system can provide an alert at the appropriate time, such as for a structured test, otherwise it does not provide an alert. In another example, the system and technique can be used to automatically download data to a patient's personal computer. This technique and system can be used for automatically syncing with other diabetes devices, such as insulin pumps or continuous monitoring devices.

Generally speaking, the system and technique described herein establishes a communication conduit between two devices (e.g., both being ambulatory, one fixed and the other being ambulatory, or one ambulatory and the other being a conduit device). The conduit is established via a low power mechanism, then going to a radio frequency (RF) basis. A handshaking protocol is utilized to assure the devices are approved by the user to communicate. From there, the combined devices can performed a number of different actions. For instance, the combined devices can transfer configuration information, such as to establish a new configuration or change an existing configuration. As another example, the combined devices can transfer data, like blood glucose measurements, insulin infusion information, and the like, as well as status information and control information. In still yet another example, the combined devices can enable or disable features, such as structured tests. As should be recognized, the system does not need to know the specific feature set for an individual device, such as a glucose meter. Rather, the master device, such as the computer 102 and/or the reader 106, can query the slave device (e.g., the glucose meter 108) to determine what type of device the slave device is, as well as what features the slave device supports.

Moreover, the systems and devices can be constructed in other manners than is shown in FIGS. 1, 2, and 3. For example, the reader 106 and glucose meter 108 can be configured differently than what is shown in FIGS. 2 and 3. For example, this technique and system can be used in conjunction with a number of different ambulatory devices, such as discrete blood glucose meters, continuous glucose monitors, and insulin pumps, user keyfobs, and/or cell phones, to name just a few examples. The processors 202, 302 may include one or more components. For a multi-component form of the processors 202, 302, one or more components may be located remotely relative to the others or configured as a single unit. Furthermore, processors 202, 302 can be embodied in a form having more than one processing unit, such as a multi-processor configuration, and should be understood to collectively refer to such configurations as well as a single-processor-based arrangement. One or more components of the processors 202, 302 may be of an electronic variety defining digital circuitry, analog circuitry, or both. The processors 202, 302 can be of a programmable variety responsive to software instructions, a hardwired state machine, or a combination of these.

The memory 204, 304 can include one or more types of solid state memory, magnetic memory, or optical memory, just to name a few. By way of nonlimiting example, the memory 204, 304 can include solid state electronic random access memory (RAM), sequential access memory (SAM), such as first-in, first-out (FIFO) variety or last-in, first-out (LIFO) variety, programmable read only memory (PROM), electronically programmable read only memory (EPROM), or electronically erasable programmable read only memory (EEPROM); an optical disc memory (such as a blue-ray, DVD, or CD-ROM); a magnetically encoded hard disc, floppy disc, tape, or cartridge media; or a combination of these memory types. In addition, the memory 204, 304 may be volatile, non-volatile, or a hybrid combination of volatile, non-volatile varieties. The memory 204 can further include removable types of memory. The removable memory can be in the form of a non-volatile electronic memory unit, optical memory disk (such as a blue ray, DVD, or CD ROM); a magnetically encoded hard disk, floppy disk, tape, or cartridge media; a USB memory drive; or a combination of these or other removable memory types.

The I/O devices 206, 306 can include any type of input and/or output devices as would occur to those skilled in the art, such as buttons, microphones, touch screens, keyboards, displays, tactile devices, printers, speakers, and the like, to name just a few examples. Moreover, it should be recognized that the input and output devices of the I/O devices 206, 306 can be combined to form a single unit such as, for example, a touch screen or can be separate units.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A method, comprising:
receiving a short range wireless signal containing a code with a glucose meter; and
changing a state of a function of the glucose meter that corresponds to the code in response to said receiving the short range wireless signal.

2. The method according to claim 1, wherein said changing the state of the function includes enabling the function of the glucose meter.

3. The method according to claim 1, wherein said changing the state of the function includes disabling the function of the glucose meter.

4. The method according to claim 1, wherein said changing the state of the function includes replacing the function with a different function.

5. The method according to claim 1, wherein said changing the state of the function includes changing the state of the function directly on the glucose meter.

6. The method according to claim 1, wherein said changing the state of the function includes changing the state of the function indirectly by establishing a communication link in which the state of the function is programmatically changed.

7. The method according to claim 1, wherein the short range wireless signal has a maximum range of 2 meters.

8. The method according to claim 1, further comprising:
wherein the glucose meter includes an RFID tag;
the short range wireless signal includes an RFID signal; and
wherein said receiving the short range wireless signal includes receiving the RFID signal with the RFID tag of the glucose meter.

9. The method according to claim 1, wherein the function includes a structured blood glucose test.

10. The method according to claim 1, wherein the function includes a function for automatically generating a report.

11. The method according to claim 10, further comprising:
transmitting data from the glucose meter to a health care provider computer in response to said receiving the short range wireless signal; and
generating the report with the health care provider computer.

12. The method according to claim 1, wherein the function is stored in memory of the glucose meter.

13. The method according to claim 1, further comprising awakening the glucose meter from a low power state to a high power state in response to said receiving the short range wireless signal.

14. The method according to claim 1, further comprising requesting authorization with the glucose meter to change the state of the function from a user before said changing the state of the function.

15. The method according to claim 1, further comprising transmitting the short range wireless signal containing the code with a device reader that is in communication with a health care provider computer.

16. The method according to claim 1, wherein the short range wireless signal is an electromagnetic signal.

17. The method according to claim 16, wherein the short range wireless signal includes a radio signal.

18. The method according to claim 16, wherein the short range wireless signal includes a magnetic signal.

19. A method, comprising:
receiving a signal with a device reader indicating to change a state of a function on a glucose meter; and
transmitting with the device reader a short range wireless signal containing a code for changing the state of the function on the glucose meter.

20. The method according to claim 19, wherein the short range wireless signal has a maximum range of 2 meters.

21. The method according to claim 19, further comprising:
wherein the device reader includes an RFID reader; and
said transmitting includes transmitting an RFID signal with the RFID reader.

22. The method according to claim 19, wherein the dormant function includes a structured blood glucose test.

23. The method according to claim 19, further comprising:
receiving data from glucose meter with the device reader; and
generating a report automatically based on the data with a health care provider computer that communicates with the device reader without any action on the part of a health care provider.

24. The method according to claim 23, wherein said generating the report includes printing the report on paper with a printer.

25. The method according to claim 19, wherein said receiving the signal includes a health care provider pressing a button on the device reader.

26. The method according to claim 19, includes requesting a password before said transmitting the short range wireless signal.

27. The method of claim 26, further comprising:
receiving the password from a user.

28. The method according to claim 19, further comprising:
disabling the function on the glucose meter in response to said transmitting.

29. The method according to claim 19, further comprising:
disabling the function on the glucose meter in response to said transmitting.

30. (canceled)

31. A system, comprising:
a glucose meter including
memory for storing a function;
a short range wireless receiver configured to receive a short range wireless signal containing a code for changing a state of the function; and
a processor configured to change the state of the function in the memory based on the code received by the short range wireless receiver.

32. The system according to claim 31, wherein the short range wireless receiver includes an RFID tag and the short range wireless signal includes an RFID signal.

33. The system according to claim 31, wherein the short range wireless signal has a maximum range of 2 meters.

34. The system according to claim 31, wherein the function includes a structured blood glucose test.

35. The system according to claim 31, wherein the function includes a function for automatically generating a report.

36. The system according to claim 31, further comprising a device reader configured to transmit the short range wireless signal.

37. The system according to claim 36, wherein the device reader includes an RFID reader.

38. The system according to claim 36, wherein the device reader is configured to receive data from the glucose meter.

39. The system according to claim 31, further comprising a printer to automatically print a report based on information downloaded from the glucose meter.

40. The system according to claim 31, further comprising a health care provider computer.

41. The system according to claim 31, wherein the code includes a deactivation code for deactivating the function.

42. The system according to claim 31, wherein the code includes an activation code for activating the function.
